(19) United States
(12) Patent Application Publication
(10) Pub. No.: US 2012/0325587 A1
(43) Pub. Date: Dec. 27, 2012

(54) Vehicle Lift With Front Platforms And Rear Carrying Arms

(76) Inventors: Jason E. Matthews, Madison, IN (US); Douglas J. Brown, Campbellsburg, IN (US); Brian E. Kelley, Madison, IN (US); Roger A. Ward, Madison, IN (US); John E. Uhl, Madison, IN (US)

(21) Appl. No.: 13/167,301

(22) Filed: Jun. 23, 2011

Related U.S. Application Data
(63) Continuation-in-part of application No. 13/165,384, filed on Jun. 21, 2011.

(51) Int. Cl. B66F 7/28; B66F 7/10

(52) U.S. Cl. 187/216

(57) ABSTRACT

A vehicle lift that includes a pair of front platforms and a pair of rear carrying arms may be used to quickly and easily lift a vehicle.

### TECHNICAL FIELD

The present invention relates generally to vehicle lifts, and in particular a vehicle lift having front platforms and rear carrying arms. The invention will be specifically disclosed in connection with, but not limited to, a two post above ground vehicle lift having front platforms for engaging the vehicle pick-up point and a rear rotatable carrying arms for engaging the vehicle pick-up point.

### BACKGROUND

Above ground two-post vehicle lifts, as well as inground lifts, typically have pairs of rotatable carrying arms hingedly attached to a lifting element, also known as a carriage, that is reciprocable vertically such as in the case of an above ground lift. The carriage is moveable along a stationary vertical post assembly, or in the case of an inground lift the carriage is mounted to a vertically moveable post. The rotatable carrying arms are typically extendable and have pick-up plates, also known as adaptors, for engaging a vehicle pick-up point, disposed at the distal end. In use, the vehicle is positioned generally relative to the lift, then the front and rear carrying arms are moved so as to align the pick-up plates with a respective assigned position, or target, on the vehicle, which are located at the appropriate locations aligned with the vehicle pick-up points. Since vehicle width and vehicle pick-up points vary from vehicle to vehicle, and since vehicles are typically not located exactly centered in the lift bay, the carrying arms are extendable to allow lifts to handle a variety of vehicles.

In another prior art embodiment of two post vehicle lifts, platforms, also known as pads, are attached directly to the lifting element, such as arms extending from the lift uprights, which directly engage the vehicle pick-up points. In use, there are elongated platforms on either side of the lift bay, lying in the path of the vehicle tires. One pair of vehicle tires is driven over the platforms and the vehicle moved to an assigned position, or target, relative to the lift. When the vehicle is properly located relative to the target, the lift is raised and the platforms engage the vehicle pick-up points.

The present invention uniquely comprises a pair of spaced apart platforms dispose to engage either side of a vehicle toward one end of the vehicle, and a pair of spaced rotatable carrying arms disposed to be aligned with and engage vehicle pick-up points toward the other end of the vehicle.

### BRIEF DESCRIPTION OF THE DRAWINGS

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 is a perspective view of a prior art above ground, asymmetric, two post lift having rotatable carrying arms with flip up pick-up plates.

FIG. 2 is a top view of the lift of FIG. 1.

FIG. 3 is a bottom view of the lift of FIG. 1.

FIG. 4 is a perspective view of an above ground, asymmetric, two post lift constructed in accordance with the teachings of the present invention.

FIG. 5 is a top view of the lift of FIG. 4.

FIG. 6 is a bottom view of the lift of FIG. 4.

FIG. 7 is a view of one carriage, platform and rotatable carrying arm of the lift of FIG. 4.

FIG. 8 is a bottom perspective view of a platform carried by its supporting arm assembly of the lift of FIG. 4, with the inner member in an extended position.

FIG. 9 is a bottom perspective view similar to FIG. 8, showing only the platform.

FIG. 10 is bottom perspective view of the outer member of a supporting arm of the lift of FIG. 4.

FIG. 11 is an exploded perspective view of the inner member of a supporting arm of the lift of FIG. 1, showing the sandwich construction thereof.

FIG. 12 is a perspective view of the inner member of FIG. 11, assembled together.

FIG. 13 is a perspective view of the supporting arm assembly.

FIG. 14 is an exploded perspective bottom view of the platform and supporting arm assembly of the lift of FIG. 4.

FIG. 15 is an enlarged fragmentary perspective view of the connection between a supporting arm assembly and carriage of the lift of FIG. 4.

FIG. 16 is an enlarged fragmentary perspective view of the connection shown in FIG. 15, from a different angle.

FIG. 17 is a perspective view of an alternative embodiment of a platform and supporting arm.

Reference will now be made in detail to the present preferred embodiment of the invention, an example of which is illustrated in the accompanying drawings.

### DETAILED DESCRIPTION

In the following description, like reference characters designate like or corresponding parts throughout the several views. Also, in the following description, it is to be understood that terms such as front, back, inside, outside, and the like are words of convenience and are not to be construed as limiting terms. Terminology used in this patent is not meant to be limiting insofar as devices described herein, or portions thereof, may be attached or utilized in other orientations. Referring in more detail to the drawings, an embodiment of the invention will now be described.

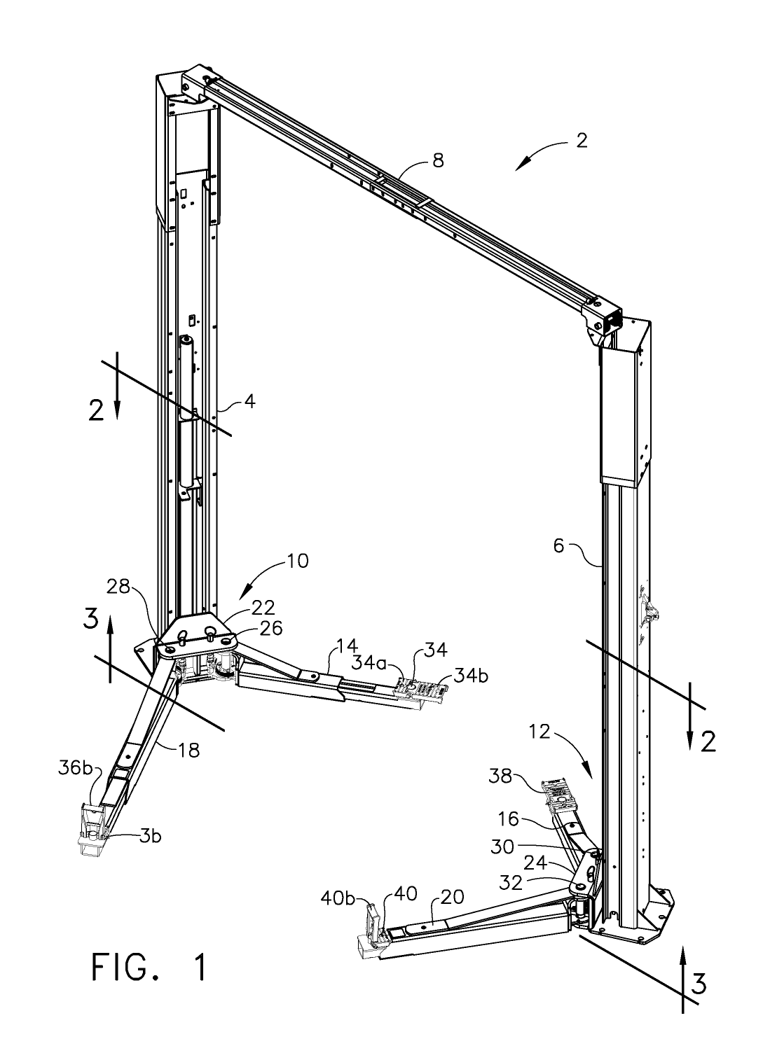

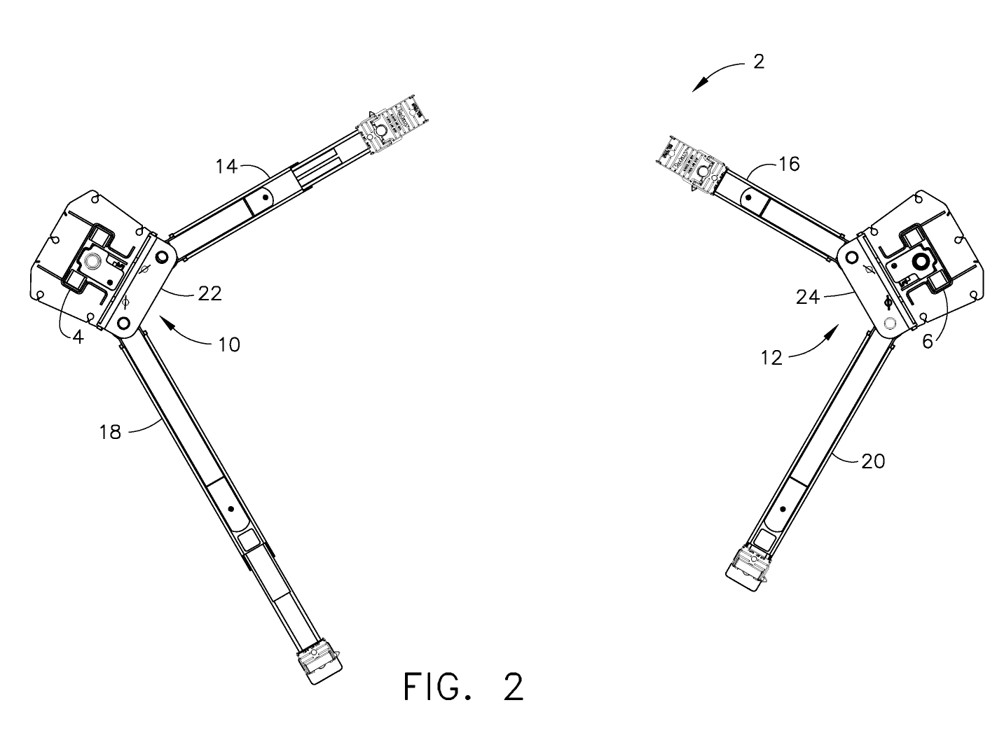

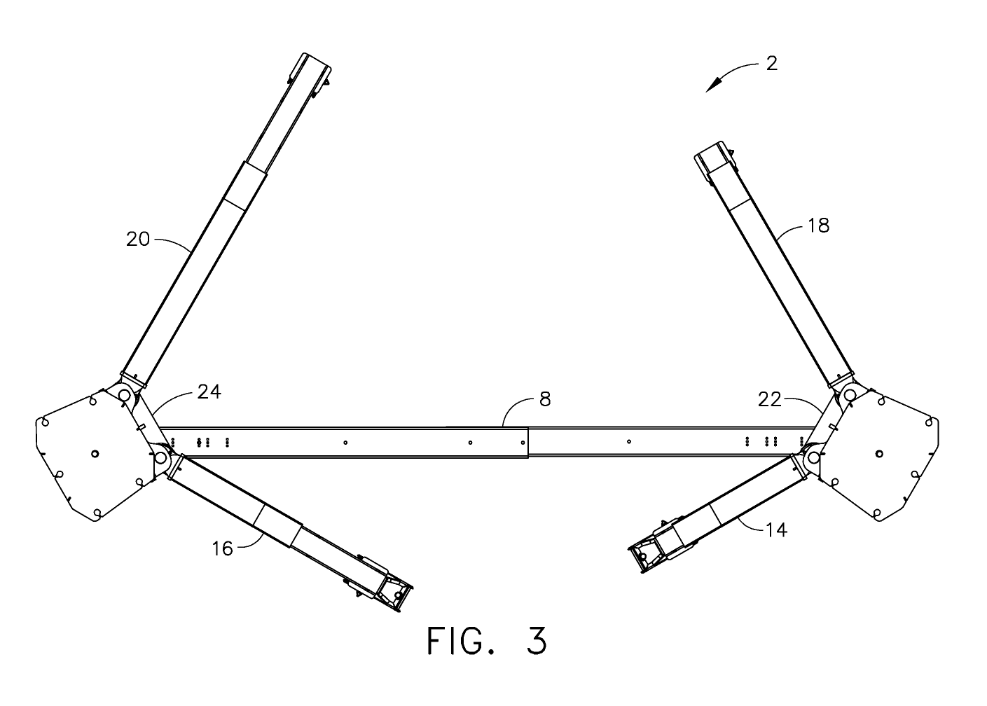

Referring to FIGS. 1-3, a known prior art above ground, two post, asymmetric vehicle lift is generally indicated at 2. Lift 2 includes two spaced apart posts 4, 6 also referred to as columns, and cross member 8. Each column 4, 6 includes respective lifting elements 10, 12, illustrated as carriages in the depicted embodiment, each of which carry respective front carrying arms 14, 16 and rear carrying arms 18, 20. Each carrying arm 14, 16, 18, 20 is extendable and is rotatably mounted to respective arm mounts 22, 24 of respective 110, 12 secured by respective hinge pins 26, 28, 30, 32.

Respective pick-up plates 34, 36, 38, 40 are carried by carrying arms 14, 16, 18, 20, disposed at respective distal ends. As is known, each pick-up plates 34, 36, 38, 40 may include for example a short member 34a and a long member 34b, both rotatable about a horizontal axis so either can be flipped up to engage the vehicle pick-up point. The different lengths provide different engagement heights to aid in maintaining the vehicle relatively level when lifted. The pick-up plate members are carried by a pin (not visible) that is rotatably carried by the respective arms 14, 16, 18, 20.

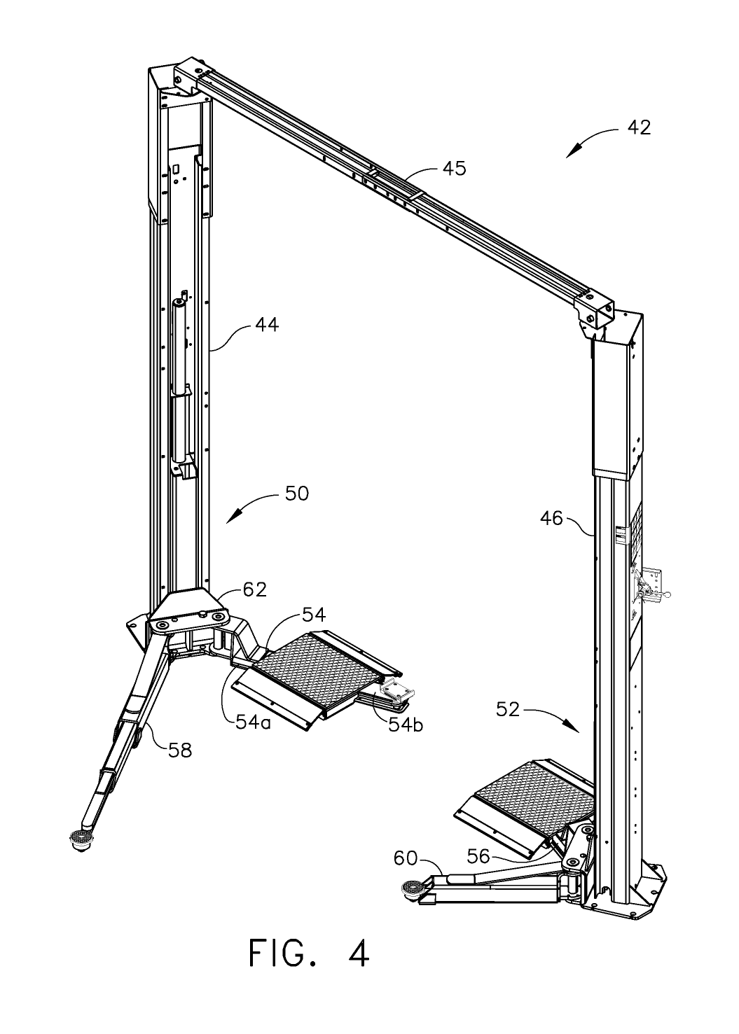

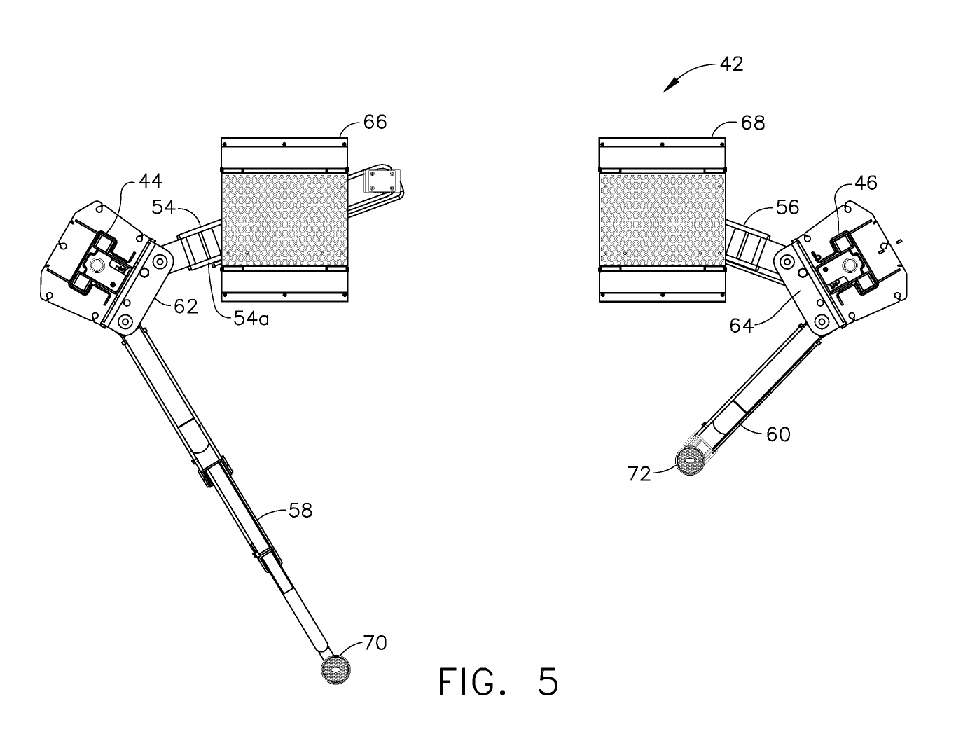

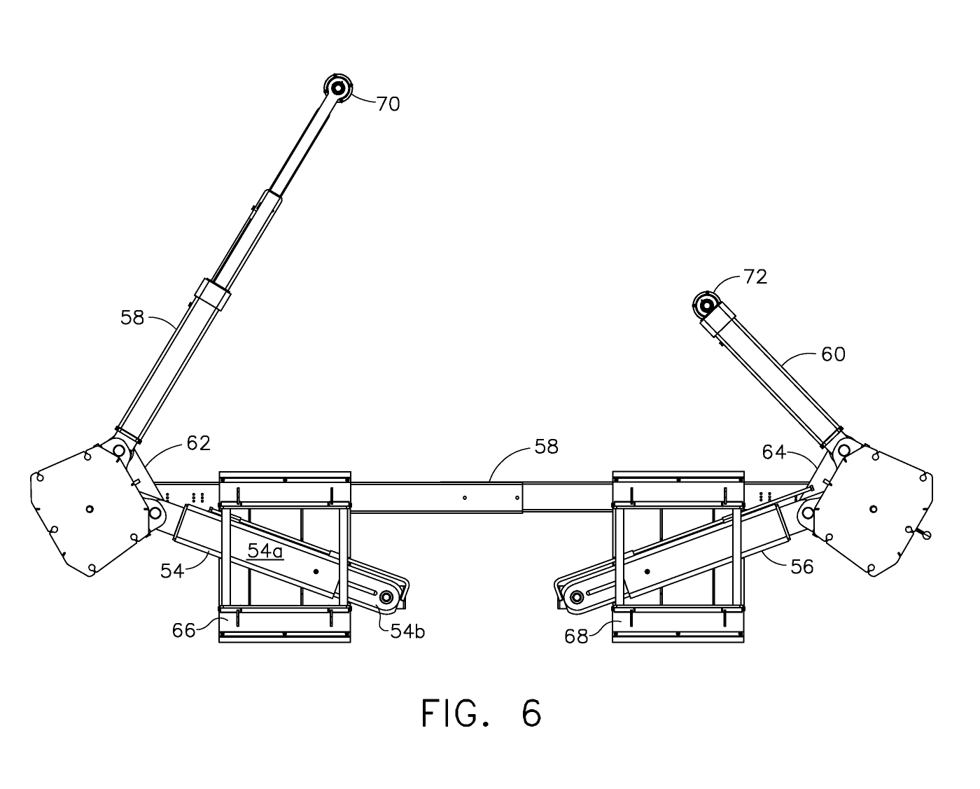

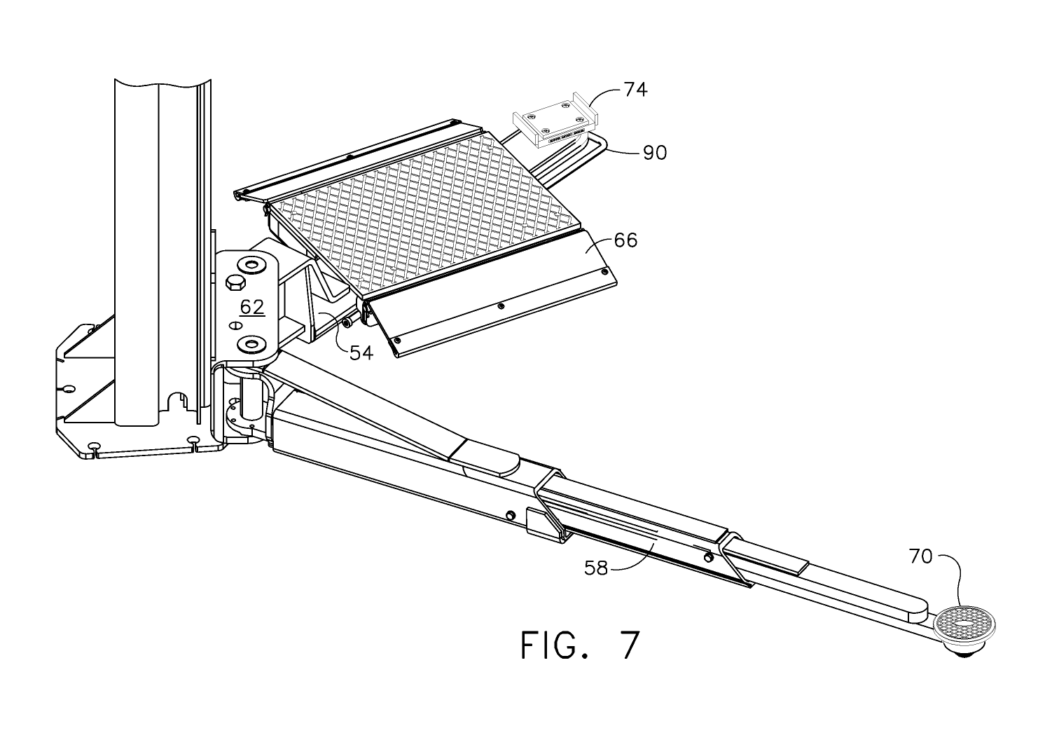

Referring to FIGS. 4-7, although the similarities of lift, generally indicated at 42, constructed in accordance with the present invention, and prior art lift 2 are readily apparent, lift 42 differs significantly. Lift 42 includes spaced apart posts 44, 46, and cross member 45. Each column 44, 46 includes respective lifting elements 50, 52 each of which carry respective front supporting arm assemblies 54, 56 and rear carrying arms 58 (shown extended), 60 (shown retracted). Supporting arm assemblies 54, 56 are mounted to arm mounts 62, 64 respectively. Carrying arms 58, 60 are extendable and are rotatably mounted to arm mounts 62, 64 respectively. Platforms 66, 68 are carried and supported by arms 54, 56 respectively. The upper surface of platforms 66, 68 may be any suitable material, such as rubber, and have any suitable surface configuration, such as that depicted. Pick-up plates 70, 72 are respectively carried by carrying arms 58, 60. Pick-up plates 70, 72 are illustrated as round and may be vertically adjustable relative to carrying arms 58, 60, respectively. Any suitable pick-up plate may be used.

Alternative embodiments of the supporting arm assembly are depicted in FIGS. 4-6. The embodiment of supporting arm assembly 54 depicted includes outer member 54a and extendable inner member 54b. Vertically adjustable pick-up plate 74 is carried by inner member 54b at its distal end. The embodiment of supporting arm assembly 56 depicted does not have an extendable inner member. Each front arm assembly of a lift will be constructed the same—either both constructed in accordance with the embodiment of supporting arm assembly 54 or both constructed in accordance with the embodiment of supporting arm assembly 56.

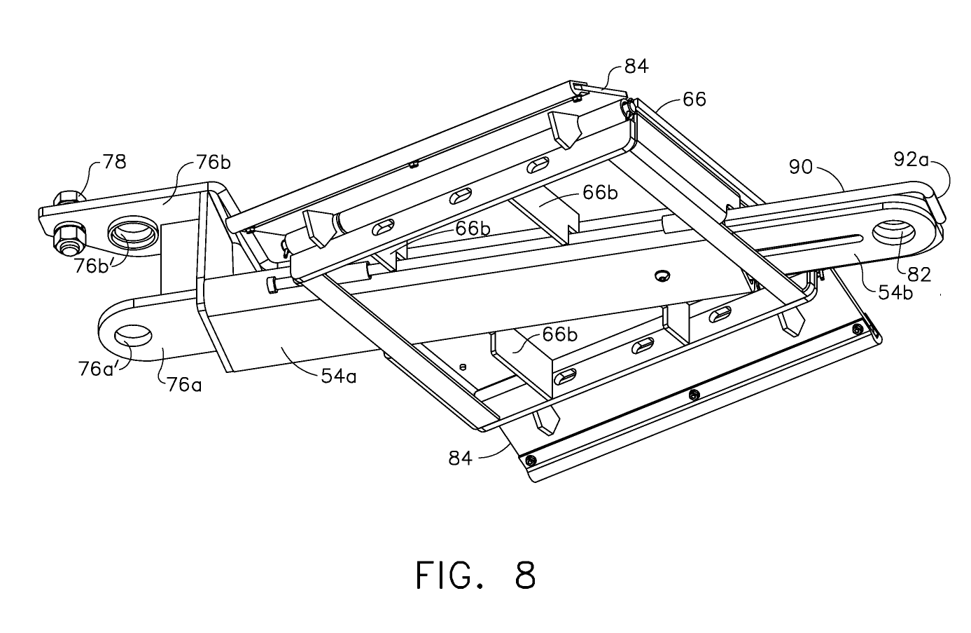

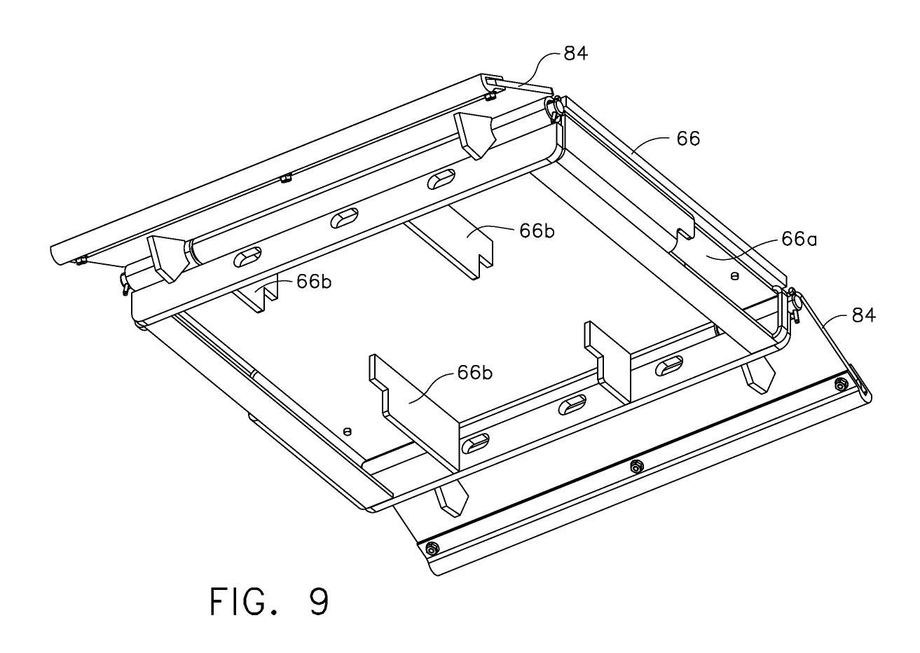

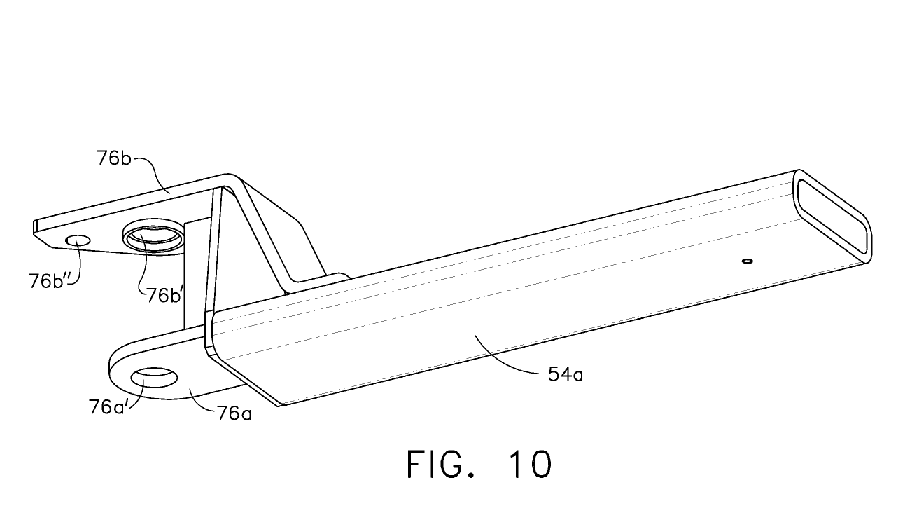

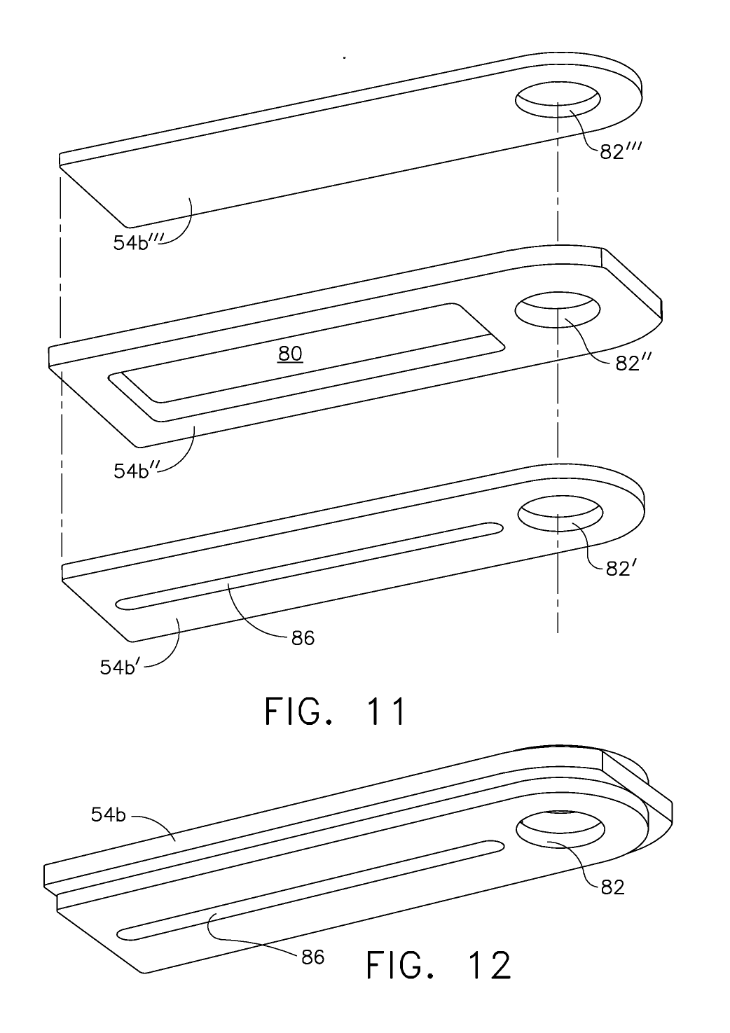

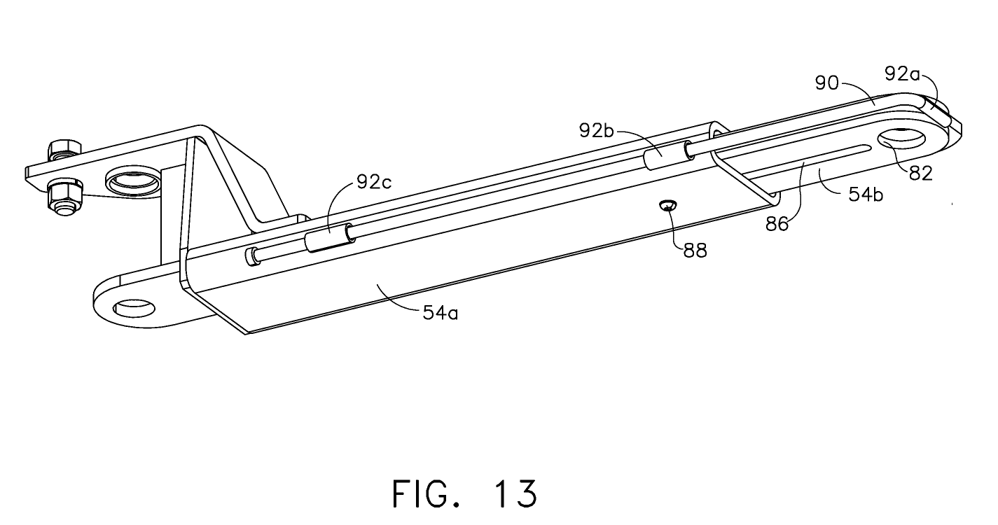

The embodiment of supporting arm assembly 54 is described in more detail by referring to FIGS. 8-13. Outer member 54a includes flanges 76a, 76b for mounting to arm mount 62. Flanges 76a, 76b includes openings 76a′, 76b′ for receiving a hinge pin, and opening 76b″ for receiving a bolt or pin 78. Outer member 54a configured to extendably receive inner member 54b allowing inner member 54b to telescope, as described below. Inner member 54b may be of any suitable construction, such as the sandwich constriction illustrated in FIGS. 11 and 12. Inner member 54b is assembled of three individual similarly shaped pieces, 54b′, 54b″, 54b′″. Middle piece 54b″ has a central cavity, 80 which, in combination with the sandwich construction, reduces the weight of inner member 54b. Each piece 54b′, 54b″, 54b′″ includes respective openings 82′, 82″, 82′, at their distal ends, which are aligned to form opening 82 which receives vertically adjustable pick-up plate 74. Opening 82 is shaped to cooperate with the configuration of vertically adjustable pick-up plate 74 consistent with the vertical adjustability functionality.

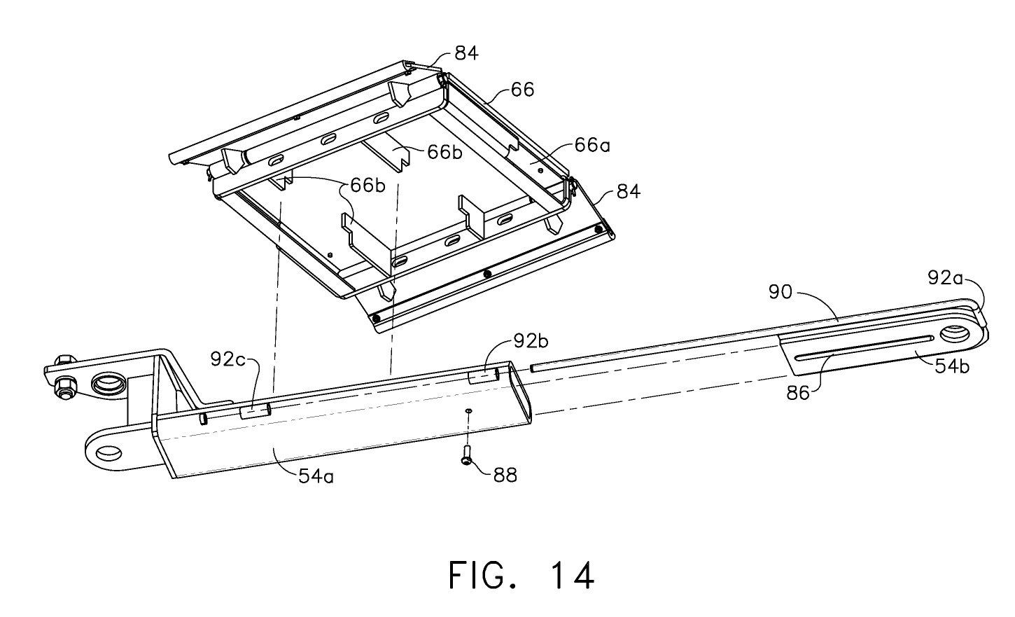

Piece 54b′ includes elongated slot 86. As seen in FIG. 14, when inner member 54b is disposed within outer member 54a, pin 88 extends into elongated slot 86 to retain inner member 54b. So that the user can effect the extension of inner member 54b when a vehicle is overlying platform 66, control rod 90 is provided. Control rod 90 is attached to the distal end of inner member 54b, such as to tube 92a welded to the distal end. Any suitable method of securing control rod 90 may be used. Control rod 90 is slidably carried by tubes 92b and 92c, which are carried by outer member 54a. Control rod 90 extends along outer member 54a to a position proximal flanges 76a, 76b, which can be accessed by the lift operator while a vehicle is overlying platform 66. This allows pick-up plate 74, when properly located vertically, to be moved to a position to engage the vehicle pick-up point instead of platform 66 engaging the vehicle pick-up point.

As also seen in FIGS. 8, 9 and 14, outer member 54a supports platform 66 on its underside. Platform 66 includes opening 66a through which inner member 54b may extend. A plurality of ribs 66b are configured to engage outer member 54, and in the embodiment depicted, platform 66 is secured to outer member 54a by welding, including welding of ribs 66b to outer member 54a. Any suitable arrangement may be used to attach and/or support platform 66. Platform 66 includes horizontally pivoting ramps 84 on either side, which may engage the lift bay floor when the lift is lowered completely, disposed adjacent the lift bay floor, providing a ramp for the vehicle tires to drive over platform 66. Supporting arm assembly 56 and platform 68 may have the same construction.

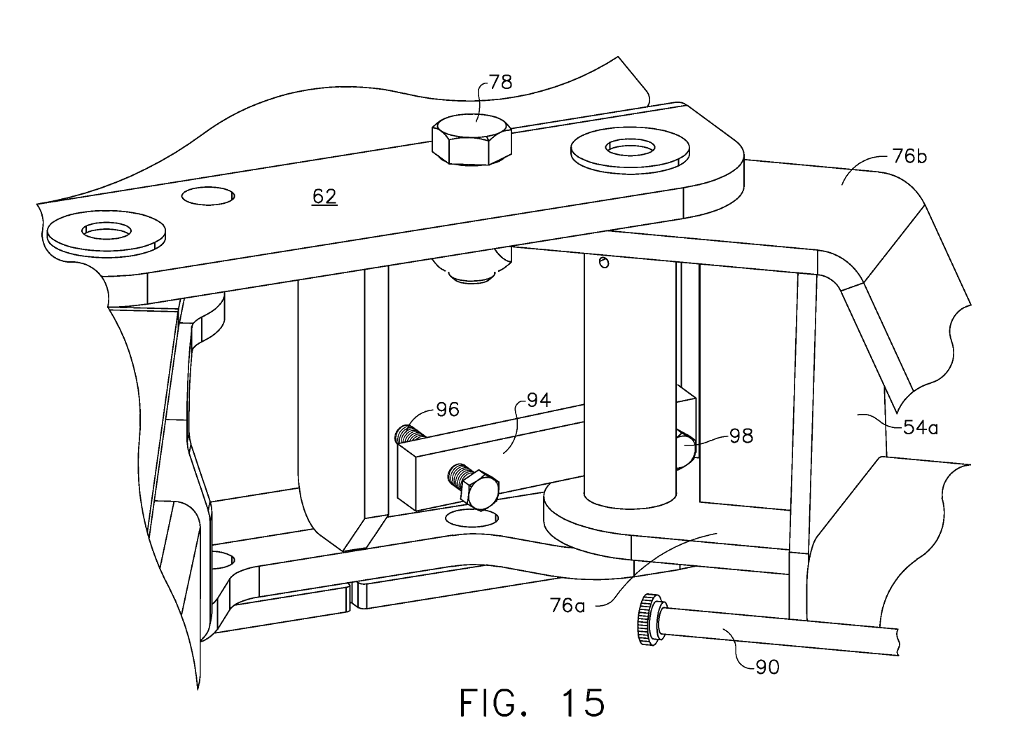

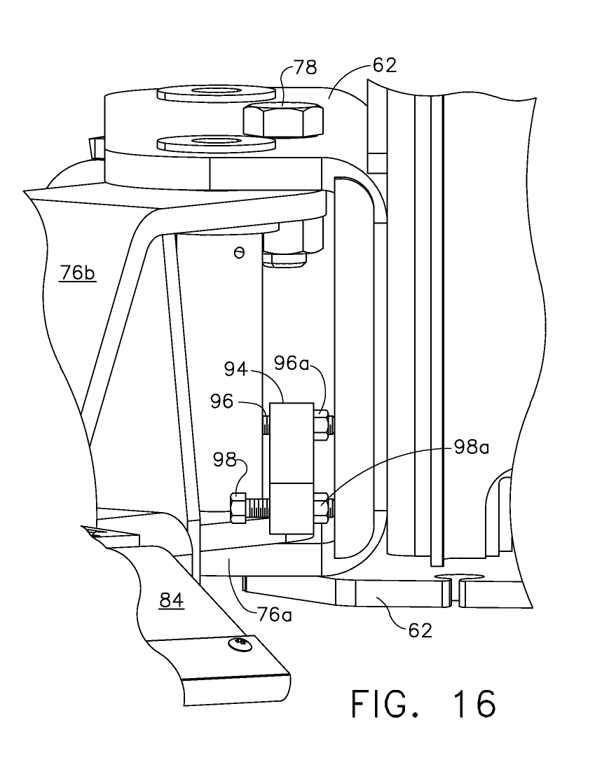

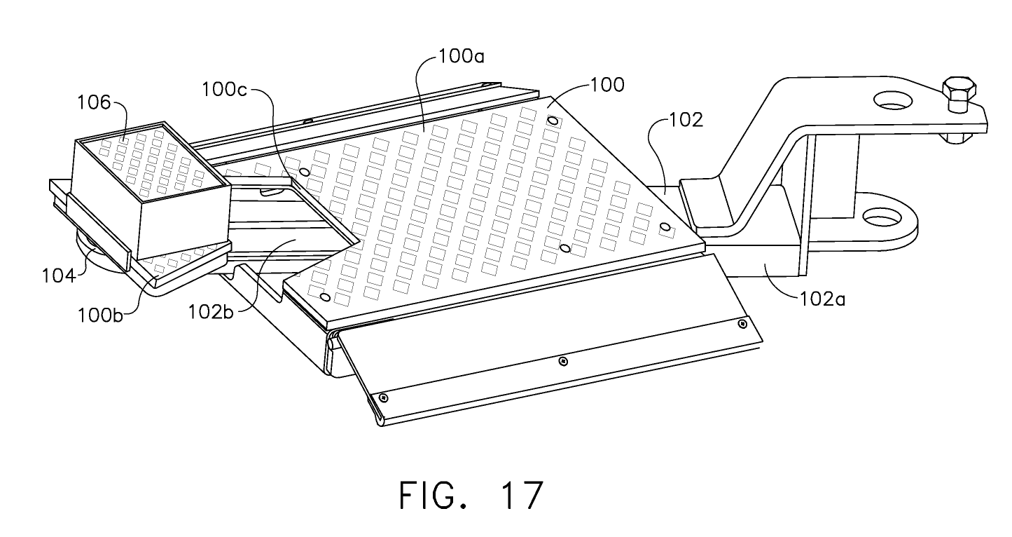

Referring to FIGS. 15 and 16, supporting arm assembly 54 may be secured against rotation relative to arm mount 62. In the embodiment depicted, bolt or pin 78 may be used for this purpose. Additionally, bracket 94 may be secured to outer member 54 such as by welding to flange 76a as shown. Bracket 94 includes two spaced apart adjusting bolts 96, 98 which may be advanced and tightened against arm mount 62 to minimize rotational movement of supporting arm assembly 54. Stop nuts 96a, 98a may be provided to keep bolts 96, 98 from loosening.

Lift 42 advantageously provides a faster and easier method of engaging the vehicle's pick-up points than is possible with the known four carrying arm known in the prior art, while providing more under vehicle access than a traditional platform superstructure. In use, with the lift in the lowest position, front platforms 66, 68 and rear carrying arms 58, 60 disposed adjacent the lift bay floor and rear carrying arms 58, 60 rotated to the sides of the lift bay, the vehicle is driven into the lift bay, with the front tires aligned with and driving across platforms 66, 68. With platforms 66, 68 as the target, the vehicle is moved relative to the front lift targets so as to align the front vehicle pick-up points with the front lift targets, platforms 66, 68. Thereafter, rear carrying arms 58, 60, are extended and rotated so as to align pick-up plates 70, 72, the lift targets to the vehicle pick-up points. This two step process, moving the vehicle relative to the first spaced apart pair of lift targets (in the embodiment depicted, platforms 66, 68) so as to align the vehicle with the lift targets, and then moving the second spaced apart pair of lift targets (in the embodiment depicted, pick-up plates 70, 72) relative to the vehicle so as to align those lift targets with the vehicle, provides a fast and easy method of engaging the vehicle's pick-up points.

FIG. 17 illustrates an alternative embodiment of a platform and supporting arm. Platform 100 and supporting arm assembly 102 is constructed similarly to platform 66 and supporting arm assembly 54. Supporting arm assembly 102 as depicted includes outer member 102a and extendable inner member 102b. Distal end 104 of extendable inner member 102b carries platform 100b, which is shaped complementarily to recess 100c in platform 100a, as though platform 100b was a cut-out of platform 100a. When extendable inner member 102b is fully retracted within outer member 102a, platform 100b is disposed in recess 100c. When extendable inner member 102b is in an extended position, such as shown in FIG. 17, pick-up pad 106 may be placed on top of platform 100a, aligned with a vehicle pick-up point.

It should be noted that although the lift describe here in, constructed in accordance with the teachings of the present invention, is an above ground, two post, asymmetric vehicle lift, the teachings of the present invention are not limited to such a lift configuration and may be used with any suitable lift configuration.

In summary, numerous benefits have been described which result from employing the concepts of the invention. The foregoing description of one or more embodiments of the invention has been presented for purposes of illustration and description. It is not intended to be exhaustive or to limit the invention to the precise form disclosed. Modifications or variations are possible in light of the above teachings. The one or more embodiments were chosen and described in order to illustrate the principles of the invention and its practical application to thereby enable one of ordinary skill in the art to utilize the invention in various embodiments and with various modifications as are suited to the particular use contemplated. It is intended that the scope of the invention be defined by the claims submitted herewith.

What is claimed is:

1. A method of lifting a vehicle having a plurality of vehicle pick-up points using a vehicle lift comprising the steps of:
a. providing a lift comprising
i. a plurality of fixed lift targets which are moveable substantially only vertically, and
ii. a plurality of moveable lift targets,
b. moving the vehicle relative to said plurality of fixed lift targets so as to align at least one of said plurality of vehicle pick-up points with a respective one of said plurality of fixed lift targets;
c. moving at least one moveable lift targets relative to the vehicle so as to align at least one of said plurality of moveable lift targets with a respective one of said plurality of vehicle pick-up points; and
c. lifting said vehicle.

2. The method of claim 1, wherein said fixed lift targets comprise platforms.

3. The method of claim 2, wherein said platforms are carried by supporting arms which are substantially non-rotating.

4. The method of claim 1, wherein said moveable lift targets comprise pick-up plates.

5. The method of claim 4, wherein said pick-up plates are carried by rotatable carrying arms.

6. A vehicle lift for lifting a vehicle, said vehicle lift defining a lift bay, said lift bay having a front and rear, said vehicle having a first plurality of vehicle pick-up located toward a first end of said vehicle and a second plurality of vehicle pick-up points located toward a second end of said vehicle, said vehicle lift comprising:
a. a pair of spaced apart platforms disposed toward said front of said lift bay, said platforms being moveable substantially only vertically; and
b. a pair of spaced apart rotatable carrying arms disposed toward said rear of said lift bay.

7. The vehicle lift of claim 6, wherein each rotatable carrying arm comprises a distal end and carries a vehicle pick-up plate disposed adjacent said distal end.

8. The vehicle lift of claim 7, wherein said platforms are configured to engage respective ones of said first plurality of vehicle pick-up points when the vehicle is located in said lift bay so as to align said respective ones of said first plurality of vehicle pick-up points with said platforms and said rotatable arms are rotatable to a position at which each vehicle pick-up plate respectively carried by a respective rotatable arm is aligned with respective ones of said second plurality of vehicle pick-up points.

9. The vehicle lift of claim 6, wherein each platform is carried by a respective supporting arm, said supporting arm being moveable substantially only vertically.

10. The vehicle lift of claim 6, wherein said lift comprises:
a. a pair of spaced apart vertical columns;
b. a respective vertically moveable lifting element carried by each vertical column;
c. a respective supporting arm carried by each respective lifting element, each respective supporting arm carrying a respective platform.

11. The vehicle lift of claim 10, wherein each vertical moveable lifting element carries a respective one of said rotatable carrying arms.

12. The vehicle lift of claim 6, wherein said lift comprises:
a. a pair spaced apart vertical columns;
b. a respective vertically moveable lifting element carried by each vertical column, each vertical lifting element carrying a respective one of said rotatable carrying arms.

13. The vehicle lift of claim 6, wherein said platforms are configured to engage respective ones of said first plurality of vehicle pick-up points when the vehicle is located in said lift bay.

14. A vehicle lift for lifting a vehicle, said vehicle lift defining a lift bay, said lift bay having a front and rear, said vehicle having a plurality of vehicle pick-up points, said vehicle lift comprising:
a. at least one pair of spaced apart platforms configured to respectively engage at least one vehicle pick-up point; and
b. at least one pair of spaced apart supporting arms, each platform being carried by a respective one of said at least one pair of spaced apart supporting arms, each supporting arm comprising:
i. an extendable member having a distal end and moveable between a first retracted position and a second extended position, said member configured to receive a pick-up plate at said distal end.

15. The vehicle lift of claim 14 further comprising a pair of pick-up plates each respectively carried at the distal end of a respective one of said extendable members.
